(19) United States
(12) Patent Application Publication
(10) Pub. No.: US 2025/0113236 A1
(43) Pub. Date: Apr. 3, 2025

(54) MEASUREMENT PROCESSING METHOD, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Kai WU, Dongguan (CN)

(73) Assignee: VIVO MOBILE COMMUNICATION CO., LTD., Dongguan (CN)

(21) Appl. No.: 18/977,915

(22) Filed: Dec. 11, 2024

Related U.S. Application Data
(63) Continuation of application No. PCT/CN2023/099104, filed on Jun. 8, 2023.

(30) Foreign Application Priority Data
Jun. 15, 2022 (CN) 202210685446.7

(51) Int. Cl. H04W 24/10; H04B 17/318; H04L 5/00

(52) U.S. Cl. CPC H04W 24/10; H04B 17/328; H04L 5/0051

(57) ABSTRACT

This application discloses a measurement processing method, a terminal, and a network side device. The measurement processing method includes: obtaining, by a terminal, at least one of measurement configuration information or reporting configuration information. The measurement configuration information is used for channel measurement between a network side device and a backscatter communication device, and the reporting configuration information is used to report a measurement result obtained by the channel measurement.

### CROSS-REFERENCE TO RELATED APPLICATIONS

This application is a continuation of International Application No. PCT/CN 2023/099104, filed on Jun. 8, 2023, which claims priority to Chinese Patent Application No. 202210685446.7, filed on Jun. 15, 2022. The entire contents of each of the above-referenced applications are expressly incorporated herein by reference.

### TECHNICAL FIELD

This application pertains to the field of communication technologies, and specifically, to a measurement processing method, a terminal, and a network side device.

### BACKGROUND

Backscatter Communication (BSC) means that a backscatter communication device performs signal modulation by using a radio frequency signal in another device or an environment, to transmit information of the backscatter communication device, so that power consumption and costs can be reduced significantly. The backscatter communication device may be:
a backscatter communication device in conventional Radio Frequency Identification (RFID), which is usually a tag, and belongs to an Internet of Things (IoT) device (Passive-IoT);
a semi-passive tag, where downlink reception or uplink reflection of such a tag has a specific amplification capability; and
an active tag with an active sending capability, where such a tag may send information to a reader without relying on reflection of an incident signal.

However, due to a limited capability, the backscatter communication device does not support channel measurement. Due to the uncertainty of channel quality, a problem of poor communication reliability of BSC is caused.

### SUMMARY

Embodiments of this application provide a measurement processing method, a terminal, and a network side device.

According to a first aspect, a measurement processing method is provided, and the method includes:
obtaining, by a terminal, at least one of the following:
measurement configuration information, where the measurement configuration information is used for channel measurement between a network side device and a backscatter communication device; and
reporting configuration information, where the reporting configuration information is used to report a measurement result obtained by the channel measurement.

According to a second aspect, a measurement processing apparatus is provided, including:
an obtaining module, configured to obtain at least one of the following:
measurement configuration information, where the measurement configuration information is used for channel measurement between a network side device and a backscatter communication device; and
reporting configuration information, where the reporting configuration information is used to report a measurement result obtained by the channel measurement.

According to a third aspect, a measurement processing method is provided, and the method includes:
sending, by a network side device, at least one of the following:
measurement configuration information, where the measurement configuration information is used for channel measurement between the network side device and a backscatter device; and
reporting configuration information, where the reporting configuration information is used to report a measurement result obtained by the channel measurement.

According to a fourth aspect, a measurement processing apparatus is provided, including:
a sending module, configured to send at least one of the following:
measurement configuration information, where the measurement configuration information is used for channel measurement between a network side device and a backscatter device; and
reporting configuration information, where the reporting configuration information is used to report a measurement result obtained by the channel measurement.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface, where the communication interface is configured to obtain at least one of the following:
measurement configuration information, where the measurement configuration information is used for channel measurement between a network side device and a backscatter communication device; and
reporting configuration information, where the reporting configuration information is used to report a measurement result obtained by the channel measurement.

According to a seventh aspect, a network side device is provided. The network side device includes a processor and a memory, the memory stores a program or an instruction that can be run on the processor, and when the program or the instruction is executed by the processor, the steps of the method according to the third aspect are implemented.

According to an eighth aspect, a network side device is provided, including a processor and a communication interface, where the communication interface is configured to send at least one of the following:
measurement configuration information, where the measurement configuration information is used for channel measurement between a network side device and a backscatter device; and
reporting configuration information, where the reporting configuration information is used to report a measurement result obtained by the channel measurement.

According to a ninth aspect, a measurement processing system is provided, including a terminal and a network side device. The terminal may be configured to perform the steps of the measurement processing method according to the first aspect, and the network side device may be configured to perform the steps of the measurement processing method according to the third aspect.

According to a tenth aspect, a readable storage medium is provided. The readable storage medium stores a program or an instruction, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction to implement the method according to the first aspect or the method according to the third aspect.

According to a twelfth aspect, a computer program product/program product is provided. The computer program product/program product is stored in a storage medium, and the computer program/program product is executed by at least one processor to implement the steps of the method according to the first aspect or the steps of the method according to the third aspect.

In the embodiments of this application, for a channel (a transmission channel) between a network side device and a backscatter communication device, by obtaining measurement configuration information, a terminal can perform channel measurement based on the measurement configuration information or cooperate with the network side device to perform channel measurement, and by obtaining reporting configuration information, the terminal can report, based on the reporting configuration information, a measurement result obtained by the channel measurement. In this way, quality of the channel between the network side device and the backscatter communication device can be determined, so that a problem of poor communication reliability caused by uncertainty of the channel quality is avoided.

### BRIEF DESCRIPTION OF DRAWINGS

FIG. 1 is a block diagram of a wireless communication system;

FIG. 2 is a first schematic flowchart of a method according to an embodiment of this application;

FIG. 3 is a first schematic diagram of backscatter communication;

FIG. 4 is a second schematic diagram of backscatter communication;

FIG. 5 is a first schematic diagram of application of a method according to an embodiment of this application;

FIG. 6 is a second schematic diagram of application of a method according to an embodiment of this application;

FIG. 7 is a second schematic flowchart of a method according to an embodiment of this application;

FIG. 8 is a schematic diagram of modules of an apparatus corresponding to FIG. 2;

FIG. 9 is a schematic diagram of modules of an apparatus corresponding to FIG. 7;

FIG. 10 is a schematic structural diagram of a communication device according to an embodiment of this application;

FIG. 11 is a schematic structural diagram of a terminal according to an embodiment of this application; and

FIG. 12 is a schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a wireless network communication technology (Wireless Fidelity (WiFi)) node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station.

In the embodiments, a tag is used as an example of a backscatter communication device for description.

In the embodiments, the backscatter communication includes transmission of the following content:
(1) Carrier wave (CW): In an embodiment, the carrier wave may be sent by a network side device to a tag, or may be sent by a terminal to a tag.
(2) Control command, such as a select command, a query command, a repeated query command, a reply command, a read command, a write command, and a random request command: In an embodiment, the control command may be sent by a network side device to a tag, or may be sent by a terminal to a tag.

In some embodiments, the control command may include at least one of the following: a select-type command, a query-type command, or an access command. The select-type command includes at least one of the following: a select command (a specific select command), an inventory command, or a sort command. The query-type command includes at least one of the following: a query command (a specific query command), an adjustment query command, or a repeated query command. The access command includes at least one of the following: a random request command, a read command, a write command, a kill command, a lock command, an access command, a security-related access command, or a file management-related access command.

The select-type command is mandatory. Because a tag has a plurality of attributes, based on a criteria and a policy that are set by a user, the select-type command is used, and if some attributes and flags are changed, a specific tag group is selected or delineated, so that only an inventory identification or access operation is performed on the attributes and flags. This helps reduce conflicts and repeated identification, and a recognition speed can be accelerated.

A command at an inventory phase is used to start inventory once. For example, the query command is used to start one round of inventory and determine which marks participate in this round of inventory. The adjustment query command is used to adjust a quantity of original receiving slots of the tag. The repeated query command is used to reduce a number of a label slot.

In the access command, a random access request (Req_RN) command requires a tag to generate a random number. The read command is used to read data from a location in label storage. The write command is used to write data into the label storage. The kill command can prevent leakage of privacy, making a tag to be unable to be used any more. The lock command is used to make the tag unable to perform a write action any more, preventing data from being tampered with randomly. The access command is used to change a tag from an open state to a secure state when the tag has a password. The security-related access command is used to ensure security of the tag. The file management-related access command can be used to manage files in a tag.
(3) Backscatter-related information, such as tag identification information (such as a 16-bit random number that temporarily represents a tag identity in a query process), electronic product code information, or tag status information. In an embodiment, a backscatter channel or signal may be sent by a tag to a terminal through backscattering, or may be sent by a tag to a network side device through backscattering.

With reference to the accompanying drawings, a measurement processing method in the embodiments of this application is described in detail below by using specific embodiments and application scenarios thereof.

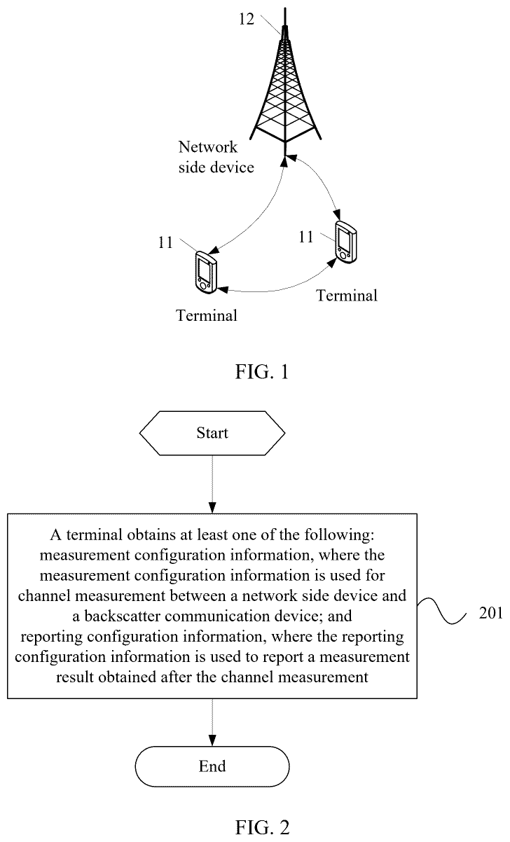

As shown in FIG. 2, a measurement processing method in an embodiment of this application includes the following steps:
Step 201: A terminal obtains at least one of the following:
measurement configuration information, where the measurement configuration information is used for channel measurement between a network side device and a backscatter communication device; and
reporting configuration information, where the reporting configuration information is used to report a measurement result obtained by the channel measurement.

Because a capability of a backscatter communication device is limited, the backscatter communication device cannot independently perform channel measurement by receiving or sending a reference signal. In some backscatter communication scenarios, because a location of the terminal and a location of the backscatter communication device are relatively close to each other, a transmission channel between the terminal and a network side device may be approximated as a transmission channel between the backscatter communication device and the network side device to some extent. Therefore, channel quality of a communication link between the network side device and the backscatter communication device may be approximately measured by receiving or sending a reference signal by the terminal. In this embodiment, for a channel (a transmission channel) between the network side device and the backscatter communication device, by obtaining the measurement configuration information, the terminal can perform the channel measurement based on the measurement configuration information or cooperate with the network side device to perform the channel measurement, and by obtaining the reporting configuration information, the terminal can report, based on the reporting configuration information, the measurement result obtained by the channel measurement. In this way, quality of the channel between the network side device and the backscatter communication device can be determined, so that a problem of poor communication reliability caused by uncertainty of the channel quality is avoided.

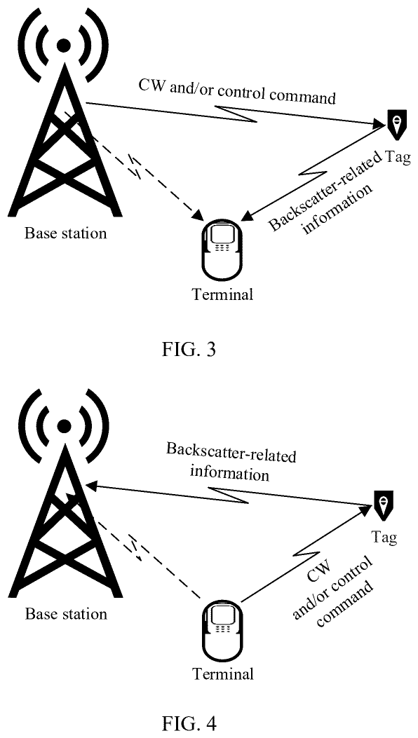

In some embodiments, the channel between the network side device and the backscatter communication device can be used to transmit at least one of the following: a carrier wave (CW), a control command, and backscatter-related information. For example, the method in this embodiment of this application is applied to a communication scenario shown in FIG. 3 in which the network side device (such as a base station) sends a CW and/or a command to the backscatter communication device (such as a tag), and the tag sends backscatter-related information to the terminal, and the channel measurement is channel measurement used to transmit the CW and/or the command; or the method in this embodiment of this application is applied to a communication scenario shown in FIG. 4 in which the terminal sends a CW and/or a command to the backscatter communication device (such as a tag), and the tag sends backscatter-related information to the network side device (such as a base station), and the channel measurement is channel measurement used to transmit the backscatter-related information.

In some embodiments, in this embodiment, the terminal receives the measurement configuration information and/or the reporting configuration information that are/is sent by the network side device.

In some embodiments, in this embodiment, the measurement configuration information includes at least one of the following:
a measurement resource;
a measurement metric;
a periodicity type;
a periodicity length; and
reference signal-related configuration information. It may be understood that the reference signal is a reference signal used for the channel measurement.

The periodicity type is a periodicity type of a measurement resource corresponding to transmission of the reference signal. The periodicity length is also a periodicity length of the measurement resource, for example, the periodicity length is 10 ms, 20 ms, or 40 ms.

In some embodiments, in this embodiment, the periodicity type includes at least one of the following:
periodic;
semi-static; and
aperiodic.

In other words, the foregoing measurement may be periodic, semi-static, or aperiodic measurement.

In some embodiments, in this embodiment, the reference signal includes at least one of the following:
a carrier wave;
a control command; and
a preamble.

Herein, if the reference signal is a carrier wave, the carrier wave is a carrier wave used for the channel measurement; if the reference signal is a control command, the control command is a control command used for the channel measurement; and if the reference signal is a preamble, the preamble is a preamble used for the channel measurement.

In some embodiments, in a case that the reference signal is control signaling, the control signaling does not trigger backscatter of the backscatter communication device, that is, does not trigger tag feedback. In another embodiment, in a case that the reference signal is control signaling, the reference signal may be configured to trigger backscatter of the backscatter communication device.

In some embodiments, in this embodiment, the reference signal-related configuration information includes at least one of the following:
time domain resource information;
frequency domain resource information;
transmit power information;
a modulation scheme;
a coding scheme;
a mapping scheme;
resource density; and
a signaling format.

In some embodiments, the foregoing time domain resource information is time domain resource information of the measurement resource, for example, a time domain location or a time domain length (size); and the foregoing frequency domain resource information is frequency domain resource information of the measurement resource.

In an embodiment, the frequency domain resource information includes at least one of the following: a frequency domain location (including at least one of a frequency band, a center frequency, a serving cell, a bandwidth part (BWP)) and a frequency domain length (size).

In some embodiments, at least one of transmit power information (such as a transmit power size), a modulation scheme, a coding scheme, a mapping scheme, resource density, or a signaling format (such as a long-short signaling format) may be specified in advance, or may be configured by the network side device.

In some embodiments, in this embodiment, the measurement metric includes at least one of the following:
Reference Signal Receiving Power (RSRP);
Reference Signal Receiving Quality (RSRQ);
a Received Signal Strength Indication (RSSI);
a Signal to Interference plus Noise Ratio (SINR); and
a channel quality indicator (CQI).

It should be noted that the reference signal refers to a reference signal used for the channel measurement.

In some embodiments, in this embodiment, the RSRP is received signal power on a resource that carries a reference signal within first bandwidth and centered on a first frequency. It may be understood that the resource that carries the reference signal in the first bandwidth refers to a resource on which the reference signal is placed. In addition, the first bandwidth may be bandwidth of a currently activated BWP, which is not limited herein. The first frequency may be a carrier frequency, a subcarrier frequency, or a frequency specified in a protocol or configured by the network side device.

The RSSI is received signal power within second bandwidth and centered on a second frequency. The second frequency may be a carrier frequency, a subcarrier frequency, or a frequency specified in a protocol or configured by the network side device. In some embodiments, the first frequency is the same as or different from the second frequency.

The RSRQ is obtained based on the RSRP and the RSSI.

The SINR is obtained based on received power of a useful signal, interference power, and noise power.

The CQI is obtained based on at least one of the following:
reception of a single antenna, a rank indicator being equal to 1, and a preset precoding matrix indication.

In some embodiments, the first frequency and the second frequency may be carrier (also referred to as subcarrier) frequencies specified in advance or configured by the network side device, and the first frequency and the second frequency may be the same or different.

In some embodiments, the first bandwidth and the second bandwidth may also be specified in advance or configured by the network side device, and the first bandwidth and the second bandwidth may be the same or different.

In some embodiments, the received signal power may be total power or average power of received signals.

In some embodiments, the useful signal may be the foregoing reference signal, and the received power of the useful signal is the foregoing RSRP. The interference power is obtained through interference measurement that is predefined or configured by the network side device.

Further, the RSRQ may be obtained based on the RSRP and the RSSI, and may be the RSRP divided by the RSSI.

Further, the SINR is obtained based on received power of a useful signal, interference power, and noise power, and may be calculated by using the RSRP, the interference power, and the noise power, for example, SINR=S/(I+N), where S represents the RSRP, I represents the interference power, and N represents the noise power.

It should be learned that, considering that the channel measurement may be performed by the terminal or the network side device, in this embodiment, the measurement configuration information includes at least one of the following:
first configuration information, where the first configuration information is used by the terminal to perform the channel measurement; and
second configuration information, where the second configuration information is used by the network side device to perform the channel measurement.

In other words, the first configuration information is applicable to the terminal to perform the channel measurement, and the second configuration information is applicable to the network side device to perform the channel measurement.

Further, the first configuration information includes at least one of the following:
a measurement resource;
a measurement metric;
a periodicity type;
a periodicity length; and
reference signal-related configuration information.

In this case, the foregoing content is applicable to the terminal to perform the channel measurement. The reference signal may be denoted as a first reference signal, and is a reference signal used by the terminal to perform the channel measurement. The first reference signal is sent by the network side device.

Further, the second configuration information includes at least one of the following:
a measurement resource;
a measurement metric;
a periodicity type;
a periodicity length; and
reference signal-related configuration information.

In this case, the foregoing content is applicable to the network side device to perform the channel measurement. The reference signal may be denoted as a second reference signal, and is a reference signal used by the network side device to perform the channel measurement. The second reference signal is sent by the terminal.

Both the first configuration information and the second configuration information are applicable to the foregoing descriptions of the measurement configuration information, and details are not described herein again. It should be further learned that, in the first configuration information and the second configuration information, measurement metrics may be the same or different, periodicity types may be the same or different, and related configuration information of the first reference signal and the second reference signal may be the same or different.

In addition, in this embodiment, the first configuration information can indicate a measurement resource used by the terminal to perform the channel measurement, that is, the first configuration information corresponds to the measurement resource for the channel measurement. Therefore, for example, in this embodiment, the method further includes:
performing, by the terminal, the channel measurement on a corresponding measurement resource based on the first configuration information by receiving a reference signal sent by the network side device.

In other words, for a case that the terminal performs the channel measurement, the network side device sends the reference signal (the first reference signal) on the corresponding measurement resource based on the first configuration information, and the terminal can perform the channel measurement on the measurement resource by receiving the first reference signal.

In some embodiments, in this embodiment, the method further includes:
reporting, by the terminal, the measurement result obtained by the channel measurement to the network side device.

In this way, for the channel measurement performed by the terminal, the network side device can learn the measurement result obtained by the channel measurement.

In some embodiments, the measurement result is the foregoing measurement metric or a result of a measurement item.

In some embodiments, in this embodiment, the reporting, by the terminal, the measurement result obtained by the channel measurement to the network side device includes:
transmitting, by the terminal, the measurement result on a corresponding first reporting resource based on the reporting configuration information; or
transmitting, by the terminal, the measurement result on a second reporting resource, where the second reporting resource is used by the terminal to report backscatter-related information.

In other words, in one aspect, the terminal may transmit, based on the obtained reporting configuration information, the measurement result by using the first reporting resource indicated by the reporting configuration information. In another aspect, the second reporting resource used by the terminal to report the backscatter-related information may be used to simultaneously transmit the measurement result.

Considering a case that the network side device performs the channel measurement, optionally, in this embodiment, the method further includes:
sending, by the terminal, a reference signal to the network side device based on the second configuration information.

In this way, the terminal sends the reference signal (the second reference signal) on a corresponding measurement resource based on the second configuration information, and the network side device can perform the channel measurement on the measurement resource by receiving the second reference signal.

In addition, the network side device can determine a transmission strategy adjustment indication based on the measurement result of the channel measurement, to adjust a transmission parameter of backscatter communication and achieve better backscatter communication. The transmission strategy adjustment indication can represent an expectation for the transmission parameter of the backscatter communication, that is, an adjustment target. The network side device can notify the terminal and/or the backscatter communication device of the transmission strategy adjustment indication. Therefore, for example, in this embodiment, the method further includes:
obtaining, by the terminal, a transmission strategy adjustment indication of the network side device; and
adjusting, by the terminal, a transmission parameter of backscatter communication according to the transmission strategy adjustment indication, where the transmission strategy adjustment indication is determined by the network side device based on the measurement result.

Herein, the transmission parameter includes at least one of the following: time domain resource information, frequency domain resource information (such as a transmit frequency band or a center frequency), transmit power information, and a modulation scheme (such as Double Sideband-Amplitude Shift Keying (DSB-ASK), Single Sideband-Amplitude Shift Keying (SSB-ASK), or Phase Reverse-Amplitude Shift Keying (PR-ASK)). The transmission parameter may further include other items, which are not listed one by one herein. The transmission strategy adjustment indication may be understood as a transmission parameter update instruction.

In some embodiments, in this embodiment, the reporting configuration information includes at least one of the following:
a periodicity type;
a periodicity length; and
reporting resource information.

Herein, the periodicity type is a periodicity type of a reporting resource, and may be periodic, semi-static, or aperiodic. The periodicity length is also a periodicity length of the reporting resource. The reporting resource information includes time domain resource information and/or frequency domain resource information. Herein, the time domain resource information is time domain resource information of the reporting resource, for example, a time domain location or a time domain length (size). The frequency domain resource information is frequency domain resource information of the reporting resource. In an embodiment, the frequency domain resource information includes at least one of the following: a frequency domain location (including at least one of a frequency band, a center frequency, a serving cell, and a BWP) and a frequency domain length (size).

In some embodiments, in this embodiment, a frequency at which the terminal performs the channel measurement is larger than or equal to a frequency at which the measurement result is reported based on the channel measurement.

For example, this is shown in Table 1.

TABLE 1

| | Periodic | Semi-static | Aperiodic |
|---|---|---|---|
| | reporting | reporting | reporting |
| Periodic measurement | Support | Support | Support |
| Semi-static measurement | Not Support | Support | Support |
| Aperiodic measurement | Not Support | Not Support | Support |

If the terminal supports periodic measurement, the terminal can support periodic reporting, semi-static reporting, and aperiodic reporting. If the terminal supports semi-static measurement, the terminal supports semi-static reporting and non-periodic reporting, and does not support periodic reporting. If the terminal supports aperiodic measurement, the terminal supports aperiodic reporting, and does not support periodic reporting or semi-static reporting.

Specific application of the method in this embodiment of this application is described below with reference to specific scenarios.

Scenario 1: As shown in FIG. 5, a base station sends a reference signal, and a terminal receives the reference signal and performs channel measurement between the base station and a tag.

First configuration information configured by the base station includes: a periodicity type of a measurement resource is periodic; the reference signal is a first carrier wave used for measurement, and related configuration information of the first carrier wave, such as a transmit power size, a center frequency, a frequency band, a modulation scheme, a coding scheme, and a signaling format, is preconfigured by a network side; and measurement metrics are RSRP, a SINR, and a CQI.

In this way, the base station sends, on the periodic first measurement resource based on the first configuration information, the reference signal used for measurement, that is, the first carrier wave. The terminal performs channel measurement on the first measurement resource by receiving the first carrier wave, and then reports, by using a reporting resource for backscatter-related information, a measurement result obtained by the channel measurement. The base station further determines a transmission strategy adjustment indication based on the reported measurement result, and instructs the terminal and/or the tag to adjust a transmission parameter of backscatter communication.

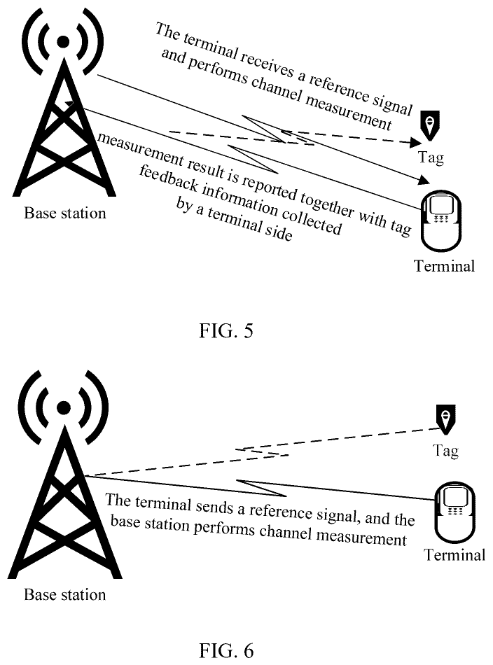

Scenario 2: As shown in FIG. 6, a terminal sends a reference signal, and a base station performs channel measurement between the base station and a tag.

Second configuration information configured by the base station includes: a periodicity type of a measurement resource is aperiodic; the reference signal is a second carrier wave used for measurement, and related configuration information of the second carrier wave, such as a transmit power size, a center frequency, a frequency band, a modulation scheme, a coding scheme, and a signaling format, is preconfigured by a network side; and measurement metrics are RSRP, a SINR, and a CQI.

In this way, the terminal receives the second configuration information sent by the base station, and sends, on the second measurement resource based on the second configuration information, the reference signal used for measurement, that is, the second carrier wave. The base station performs channel measurement on the second measurement resource by receiving the second carrier wave, and then further determines a transmission strategy adjustment indication based on a measurement result obtained by the channel measurement, to instruct the terminal and/or the tag to adjust a transmission parameter of backscatter communication.

In summary, in the method in this embodiment of this application, by obtaining the measurement configuration information and/or the reporting configuration information, the terminal provides the measurement result of the channel measurement for a network by using receiving/sending the reference signal. Further, the network may adapt to a channel change in a timely manner by using the measurement result, and adjust the transmission parameter.

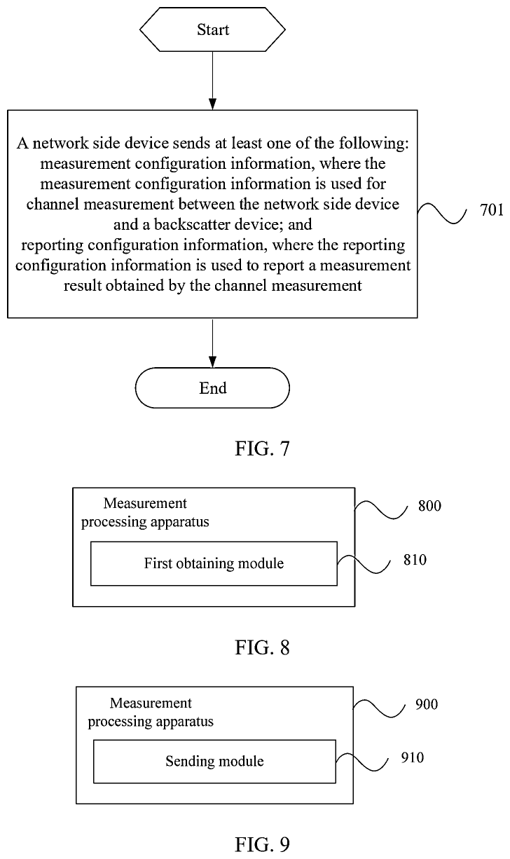

As shown in FIG. 7, a measurement processing method in an embodiment of this application includes the following steps:
Step 701: A network side device sends at least one of the following:
measurement configuration information, where the measurement configuration information is used for channel measurement between the network side device and a backscatter device; and
reporting configuration information, where the reporting configuration information is used to report a measurement result obtained by the channel measurement.

Because a capability of a backscatter communication device is limited, the backscatter communication device cannot independently perform channel measurement by receiving or sending a reference signal. In some backscatter communication scenarios, because a location of a terminal and a location of the backscatter communication device are relatively close to each other, a transmission channel between the terminal and the network side device may be approximated as a transmission channel between the backscatter communication device and the network side device to some extent. Therefore, channel quality of a communication link between the network side device and the backscatter communication device may be approximately measured by receiving or sending a reference signal by the terminal. In this embodiment, for a channel (a transmission channel) between the network side device and the backscatter communication device, the network side device configures and sends the measurement configuration information and/or the reporting configuration information to the terminal. In this way, by obtaining the measurement configuration information, the terminal can perform channel measurement based on the measurement configuration information or cooperate with the network side device to perform channel measurement, and by obtaining the reporting configuration information, the terminal can report, based on the reporting configuration information, the measurement result obtained by the channel measurement. In this way, quality of the channel between the network side device and the backscatter communication device can be determined, so that a problem of poor communication reliability caused by uncertainty of the channel quality is avoided.

In some embodiments, in this embodiment, the measurement configuration information or first measurement information or second configuration information includes at least one of the following:
a measurement resource;
a measurement metric;
a periodicity type;
a periodicity length; and
reference signal-related configuration information. It may be understood that the reference signal is a reference signal used for the channel measurement.

The periodicity type is a periodicity type of a measurement resource corresponding to transmission of the reference signal. The periodicity length is also a periodicity length of the measurement resource, for example, the periodicity length is 10 ms, 20 ms, or 40 ms.

In some embodiments, in this embodiment, the periodicity type includes at least one of the following:
periodic;
semi-static; and
aperiodic.

In other words, the foregoing measurement may be periodic, semi-static, or aperiodic measurement.

In some embodiments, in this embodiment, the reference signal includes at least one of the following:
a carrier wave;
a control command; and
a preamble.

Herein, if the reference signal is a carrier wave, the carrier wave is a carrier wave used for the channel measurement; if the reference signal is a control command, the control command is a control command used for the channel measurement; and if the reference signal is a preamble, the preamble is a preamble used for the channel measurement.

In some embodiments, the following may be specified in advance or configured: in a case that the reference signal is control signaling, the control signaling does not trigger backscatter of the backscatter communication device, that is, does not trigger tag feedback. In another embodiment, in a case that the reference signal is control signaling, the reference signal may be configured to trigger backscatter of the backscatter communication device.

In some embodiments, in this embodiment, the reference signal-related configuration information includes at least one of the following:
time domain resource information;
frequency domain resource information;
transmit power information;
a modulation scheme;
a coding scheme;
a mapping scheme;
resource density; and
a signaling format.

In some embodiments, the foregoing time domain resource information is time domain resource information of the measurement resource, such as a time domain location or a time domain length (size); and the foregoing frequency domain resource information is frequency domain resource information of the measurement resource.

In an embodiment, the frequency domain resource information includes at least one of the following: a frequency domain location (including at least one of a frequency band, a center frequency, a serving cell, and a BWP) and a frequency domain length (size).

In some embodiments, at least one of transmit power information (such as a transmit power size), a modulation scheme, a coding scheme, a mapping scheme, resource density, or a signaling format (such as a long-short signaling format) may be specified in advance, or may be configured by the network side device.

In some embodiments, in this embodiment, the measurement metric includes at least one of the following:
reference signal received power RSRP;
reference signal received quality RSRQ;
received signal strength indication RSSI;
a signal to interference plus noise ratio SINR; and
a channel quality indicator CQI.

It should be noted that the reference signal refers to a reference signal used for the channel measurement.

In some embodiments, in this embodiment, the RSRP is received signal power on a resource that carries a reference signal within first bandwidth and centered on a first frequency. It may be understood that the resource that carries the reference signal in the first bandwidth refers to a resource on which the reference signal is placed. In addition, the first bandwidth may be bandwidth of a currently activated BWP, which is not limited herein. The first frequency may be a carrier frequency, a subcarrier frequency, or a frequency specified in a protocol or configured by the network side device.

The RSSI is received signal power within second bandwidth and centered on a second frequency. The second frequency may be a carrier frequency, a subcarrier frequency, or a frequency specified in a protocol or configured by the network side device. In some embodiments, the first frequency is the same as or different from the second frequency.

The RSRQ is obtained based on the RSRP and the RSSI.

The SINR is obtained based on received power of a useful signal, interference power, and noise power.

The CQI is obtained based on at least one of the following:
reception of a single antenna, a rank indicator being equal to 1, and a preset precoding matrix indication.

In some embodiments, the first frequency and the second frequency may be carrier (also referred to as subcarrier) frequencies specified in advance or configured by the network side device, and the first frequency and the second frequency may be the same or different.

In some embodiments, the first bandwidth and the second bandwidth may also be specified in advance or configured by the network side device, and the first bandwidth and the second bandwidth may be the same or different.

In some embodiments, the received signal power may be total power or average power of received signals.

In some embodiments, the useful signal may be the foregoing reference signal, and the received power of the useful signal is the RSRP. The interference power is obtained through interference measurement that is predefined or configured by the network side device.

Further, the RSRQ may be obtained based on the RSRP and the RSSI, and may be the RSRP divided by the RSSI.

Further, the SINR is obtained based on received power of a useful signal, interference power, and noise power, and may be calculated by using the RSRP, the interference power, and the noise power, for example, SINR=S/(I+N), where S represents the RSRP, I represents the interference power, and N represents the noise power.

In some embodiments, the measurement configuration information includes at least one of the following:
first configuration information, where the first configuration information is used by the terminal to perform the channel measurement; and
second configuration information, where the second configuration information is used by the network side device to perform the channel measurement.

In other words, the first configuration information is applicable to the terminal to measure the foregoing channel, and the second configuration information is applicable to the network side device to measure the foregoing channel.

Further, the first configuration information includes at least one of the following:
a measurement resource;
a measurement metric;
a periodicity type;
a periodicity length; and
reference signal-related configuration information.

In this case, the foregoing content is applicable to the terminal to perform the channel measurement. The reference signal may be denoted as a first reference signal, and is a reference signal used by the terminal to perform the channel measurement. The first reference signal is sent by the network side device.

Further, the second configuration information includes at least one of the following:
a measurement resource;
a measurement metric;
a periodicity type;
a periodicity length; and
reference signal-related configuration information.

In this case, the foregoing content is applicable to the network side device to perform the channel measurement. The reference signal may be denoted as a second reference signal, and is a reference signal used by the network side device to perform the channel measurement. The second reference signal is sent by the terminal.

Both the first configuration information and the second configuration information are applicable to the foregoing descriptions of the measurement configuration information, and details are not described herein again. It should be further learned that, in the first configuration information and the second configuration information, measurement metrics may be the same or different, periodicity types may be the same or different, and related configuration information of the first reference signal and the second reference signal may be the same or different.

In some embodiments, in this embodiment, the method further includes:
sending, by the network side device, a reference signal to the terminal based on the first configuration information.

The network side device sends the reference signal (the first reference signal) on the corresponding measurement resource based on the first configuration information, and the terminal can perform the channel measurement on the measurement resource by receiving the first reference signal.

Further, the terminal reports the measurement result obtained by the channel measurement to the network side device. In some embodiments, the measurement result is the foregoing measurement metric or a result of a measurement item.

In some embodiments, in one aspect, the terminal may transmit, based on the obtained reporting configuration information, the measurement result by using the first reporting resource indicated by the reporting configuration information. In another aspect, the second reporting resource used by the terminal to report backscatter-related information may be used to simultaneously transmit the measurement result.

Correspondingly, in this embodiment, the method further includes: receiving, by the network side device, a measurement result reported by the terminal.

In addition, the terminal may send the reference signal (the second reference signal) on the corresponding measurement resource based on the second configuration information. Therefore, for example, in this embodiment, the method further includes:
performing, by the network side device, the channel measurement on a corresponding measurement resource based on the second configuration information by receiving a reference signal sent by the terminal.

The network side device can perform the channel measurement on the measurement resource by receiving the second reference signal.

In some embodiments, in this embodiment, the method further includes:
determining, by the network side device, a transmission strategy adjustment indication based on the measurement result; and
performing, by the network side device, at least one of the following:
instructing to adjust a transmission parameter of backscatter communication according to the transmission strategy adjustment indication; and
sending the transmission strategy adjustment indication to the terminal.

Herein, the network side device may independently adjust the transmission parameter of the backscatter communication according to the transmission strategy adjustment indication. The transmission strategy adjustment indication may be sent to the terminal, and the terminal adjusts the transmission parameter of the backscatter communication. The network side device may further send the transmission strategy adjustment indication to the backscatter communication device, and the backscatter communication device adjusts the transmission parameter of the backscatter communication by itself.

Herein, the transmission parameter includes at least one of the following: time domain resource information, frequency domain resource information (such as a transmit frequency band or a center frequency), transmit power information, or a modulation scheme (such as DSB-ASK, SSB-ASK, or PR-ASK). The transmission parameter may further include other items, which are not listed one by one herein. The transmission strategy adjustment indication may be understood as a transmission parameter update instruction.

In some embodiments, in this embodiment, the reporting configuration information includes at least one of the following:
a periodicity type;
a periodicity length; and
reporting resource information.

Herein, the periodicity type is a periodicity type of a reporting resource corresponding to transmission of the measurement result. The periodicity length is also a periodicity length of the reporting resource. The reporting resource information includes time domain resource information and/or frequency domain resource information. Herein, the time domain resource information is time domain resource information of the reporting resource, for example, a time domain location or a time domain length (size). The frequency domain resource information is frequency domain resource information of the reporting resource. In an embodiment, the frequency domain resource information includes at least one of the following: a frequency domain location (including at least one of a frequency band, a center frequency, a serving cell, and a BWP) and a frequency domain length (size).

In some embodiments, in this embodiment, a frequency at which the terminal performs the channel measurement is larger than or equal to a frequency at which the measurement result is reported based on the channel measurement.

It should be noted that the method in this embodiment of this application is implemented in cooperation with the foregoing measurement processing method performed by the terminal. An implementation of the foregoing method embodiment is applicable to this method, and a same technical effect can also be achieved.

The measurement processing method provided in the embodiments of this application may be performed by a measurement processing apparatus. In an embodiment of this application, that the measurement processing apparatus performs the measurement processing method is used as an example to describe the measurement processing apparatus according to this embodiment of this application.

As shown in FIG. 8, a measurement processing apparatus 800 in an embodiment of this application includes:
a first obtaining module 810, configured to obtain at least one of the following:
measurement configuration information, where the measurement configuration information is used for channel measurement between a network side device and a backscatter communication device; and
reporting configuration information, where the reporting configuration information is used to report a measurement result obtained by the channel measurement.

In some embodiments, the measurement configuration information includes at least one of the following:
first configuration information, where the first configuration information is used by the terminal to perform the channel measurement; and
second configuration information, where the second configuration information is used by the network side device to perform the channel measurement.

In some embodiments, the apparatus further includes:
a first processing module, configured to perform the channel measurement on a corresponding measurement resource based on the first configuration information by receiving a reference signal sent by the network side device.

In some embodiments, the apparatus further includes:
a reporting module, configured to report the measurement result obtained by the channel measurement to the network side device.

In some embodiments, the reporting module is further configured to:
transmit the measurement result on a corresponding first reporting resource based on the reporting configuration information; or
transmit the measurement result on a second reporting resource, where the second reporting resource is used by the terminal to report backscatter-related information.

In some embodiments, the apparatus further includes:
a first reference signal sending module, configured to send a reference signal to the network side device based on the second configuration information.

In some embodiments, the apparatus further includes:
a second obtaining module, configured to obtain a transmission strategy adjustment indication of the network side device; and
a second processing module, configured to adjust a transmission parameter of backscatter communication according to the transmission strategy adjustment indication, where the transmission strategy adjustment indication is determined by the network side device based on the measurement result.

In some embodiments, the measurement configuration information includes at least one of the following:
a measurement resource;
a measurement metric;
a periodicity type;
a periodicity length; and
reference signal-related configuration information.

In some embodiments, the periodicity type includes at least one of the following:
periodic;
semi-static; and
aperiodic.

In some embodiments, the reference signal includes at least one of the following:
a carrier wave;
a control command; and
a preamble.

In some embodiments, the reference signal-related configuration information includes at least one of the following:
time domain resource information;
frequency domain resource information;
transmit power information;
a modulation scheme;
a coding scheme;
a mapping scheme;
resource density; and
a signaling format.

In some embodiments, the measurement metric includes at least one of the following:
RSRP;
RSRQ;
an RSSI;
a SINR; and
a CQI.

In some embodiments, the RSRP is received signal power on a resource that carries a reference signal within first bandwidth and centered on a first frequency.

The RSSI is received signal power within second bandwidth and centered on a second frequency.

The RSRQ is obtained based on the RSRP and the RSSI.

The SINR is obtained based on received power of a useful signal, interference power, and noise power.

The CQI is obtained based on at least one of the following:
reception of a single antenna, a rank indicator being equal to 1, and a preset precoding matrix indication.

In some embodiments, the reporting configuration information includes at least one of the following:
a periodicity type;
a periodicity length; and
reporting resource information.

In some embodiments, a frequency at which the terminal performs the channel measurement is larger than or equal to a frequency at which the measurement result is reported based on the channel measurement.

For a channel (a transmission channel) between the network side device and the backscatter communication device, by obtaining the measurement configuration information, the apparatus can perform the channel measurement based on the measurement configuration information or cooperate with the network side device to perform the channel measurement, and by obtaining the reporting configuration information, the apparatus can report, based on the reporting configuration information, the measurement result obtained by the channel measurement. In this way, quality of the channel between the network side device and the backscatter communication device can be determined, so that a problem of poor communication reliability caused by uncertainty of the channel quality is avoided.

The measurement processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The measurement processing apparatus provided in this embodiment of this application can implement the processes implemented in the method embodiment in FIG. 2 to FIG. 6, and a same technical effect is achieved. To avoid repetition, details are not described herein again.

As shown in FIG. 9, a measurement processing apparatus 900 in an embodiment of this application includes:
a sending module 910, configured to send at least one of the following:
measurement configuration information, where the measurement configuration information is used for channel measurement between a network side device and a backscatter device; and
reporting configuration information, where the reporting configuration information is used to report a measurement result obtained by the channel measurement.

In some embodiments, the measurement configuration information includes at least one of the following:
first configuration information, where the first configuration information is used by the terminal to perform the channel measurement; and
second configuration information, where the second configuration information is used by the network side device to perform the channel measurement.

In some embodiments, the apparatus further includes:
a second reference signal sending module, configured to send a reference signal to the terminal based on the first configuration information.

In some embodiments, the apparatus further includes:
a receiving module, configured to receive a measurement result reported by the terminal.

In some embodiments, the apparatus further includes:
a third processing module, configured to perform the channel measurement on a corresponding measurement resource based on the second configuration information by receiving a reference signal sent by the terminal.

In some embodiments, the apparatus further includes:
a determining module, configured to determine a transmission strategy adjustment indication based on the measurement result; and
a fourth processing module, configured to perform at least one of the following:
instructing to adjust a transmission parameter of backscatter communication according to the transmission strategy adjustment indication; and
sending the transmission strategy adjustment indication to the terminal.

In some embodiments, the measurement configuration information includes at least one of the following:
a measurement resource;
a measurement metric;
a periodicity type;
a periodicity length; and
reference signal-related configuration information.

In some embodiments, the periodicity type includes at least one of the following:
periodic;
semi-static; and
aperiodic.

In some embodiments, the reference signal includes at least one of the following:
a carrier wave;
a control command; and
a preamble.

In some embodiments, the reference signal-related configuration information includes at least one of the following:
time domain resource information;
frequency domain resource information;
transmit power information;
a modulation scheme;
a coding scheme;
a mapping scheme;
resource density; and
a signaling format.

In some embodiments, the measurement metric includes at least one of the following:
RSRP;
RSRQ;
an RSSI;
a SINR; and
a CQI.

In some embodiments, the RSRP is received signal power on a resource that carries a reference signal within first bandwidth and centered on a first frequency.

The RSSI is received signal power within second bandwidth and centered on a second frequency.

The RSRQ is obtained based on the RSRP and the RSSI.

The SINR is obtained based on received power of a useful signal, interference power, and noise power.

The CQI is obtained based on at least one of the following:
reception of a single antenna, a rank indicator being equal to 1, and a preset precoding matrix indication.

In some embodiments, the reporting configuration information includes at least one of the following:
a periodicity type;
a periodicity length; and
reporting resource information.

In some embodiments, a frequency at which the terminal performs the channel measurement is larger than or equal to a frequency at which the measurement result is reported based on the channel measurement.

For a channel (a transmission channel) between the network side device and the backscatter communication device, the apparatus sends the measurement configuration information and/or the reporting configuration information to the terminal. In this way, by obtaining the measurement configuration information, the terminal can perform channel measurement based on the measurement configuration information or cooperate with the network side device to perform channel measurement, and by obtaining the reporting configuration information, the terminal can report, based on the reporting configuration information, the measurement result obtained by the channel measurement. In this way, quality of the channel between the network side device and the backscatter communication device can be determined, so that a problem of poor communication reliability caused by uncertainty of the channel quality is avoided.

The measurement processing apparatus in this embodiment of this application may be an electronic device, such as a base station, or may be another device other than the base station. For example, the base station may include but is not limited to the foregoing listed types of the terminal 11, and the another device may be a server, a NAS, or the like. This is not specifically limited in this embodiment of this application.

The measurement processing apparatus provided in this embodiment of this application can implement the processes implemented in the method embodiment in FIG. 7, and a same technical effect is achieved. To avoid repetition, details are not described herein again.

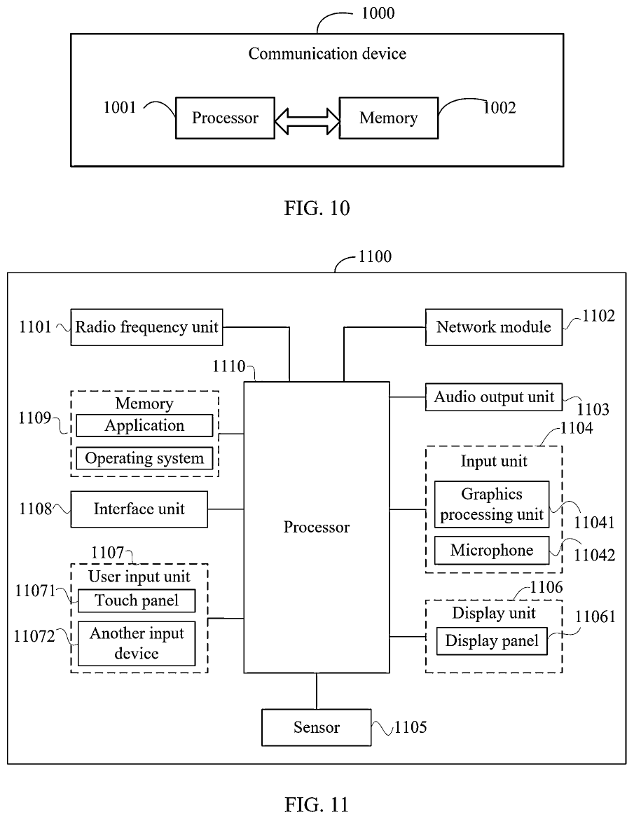

In some embodiments, as shown in FIG. 10, an embodiment of this application further provides a communication device 1000, including a processor 1001 and a memory 1002, and the memory 1002 stores a program or an instruction that can be run on the processor 1001. For example, in a case that the communication device 1000 is a terminal, when the program or the instruction is executed by the processor 1001, the steps of the foregoing embodiment of the measurement processing method performed by the terminal are implemented, and a same technical effect can be achieved. In a case that the communication device 1000 is a network side device, when the program or the instruction is executed by the processor 1001, the steps of the foregoing embodiment of the measurement processing method performed by the network side device are implemented, and a same technical effect can be achieved. To avoid repetition, details are not described herein again.

An embodiment of this application further provides a terminal, including a processor and a communication interface. The communication interface is configured to obtain at least one of the following:
measurement configuration information, where the measurement configuration information is used for channel measurement between a network side device and a backscatter communication device; and
reporting configuration information, where the reporting configuration information is used to report a measurement result obtained by the channel measurement.

This terminal embodiment is corresponding to the method embodiment on the terminal side, each implementation process and implementation of the method embodiment can be applied to the terminal embodiment, and a same technical effect can be achieved. For example, FIG. 11 is a schematic diagram of a hardware structure of a terminal according to an embodiment of this application.

The terminal 1100 includes but is not limited to at least a part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the terminal 1100 may further include a power supply (such as a battery) that supplies power to each component. The power supply may be logically connected to the processor 1110 by using a power supply management system, to implement functions such as charging and discharging management, and power consumption management by using the power supply management system. A terminal structure shown in FIG. 11 constitutes no limitation on the terminal, and the terminal may include more or fewer components than those shown in the figure, or combine some components, or have different component arrangements. Details are not described herein.

It should be understood that, in this embodiment of this application, the input unit 1104 may include a Graphics Processing Unit (GPU) 11041 and a microphone 11042, and the GPU 11041 processes image data of a still picture or a video obtained by an image capture apparatus (such as a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1109 in this embodiment of this application includes but is not limited to these memories and any memory of another proper type.

The processor 1110 may include one or more processing units. In some embodiments, an application processor and a modem processor are integrated into the processor 1110. The application processor mainly processes an operating system, a user interface, an application, or the like. The modem processor mainly processes a wireless communication signal, for example, a baseband processor. It may be understood that, in some embodiments, the modem processor may not be integrated into the processor 1110.

The radio frequency unit 1101 is configured to obtain at least one of the following:
measurement configuration information, where the measurement configuration information is used for channel measurement between a network side device and a backscatter communication device; and
reporting configuration information, where the reporting configuration information is used to report a measurement result obtained by the channel measurement.

For a channel (a transmission channel) between the network side device and the backscatter communication device, by obtaining the measurement configuration information, the apparatus can perform the channel measurement based on the measurement configuration information or cooperate with the network side device to perform the channel measurement, and by obtaining the reporting configuration information, the apparatus can report, based on the reporting configuration information, the measurement result obtained by the channel measurement. In this way, quality of the channel between the network side device and the backscatter communication device can be determined, so that a problem of poor communication reliability caused by uncertainty of the channel quality is avoided.

In some embodiments, the measurement configuration information includes at least one of the following:
first configuration information, where the first configuration information is used by the terminal to perform the channel measurement; and
second configuration information, where the second configuration information is used by the network side device to perform the channel measurement.

In some embodiments, the processor 1110 is configured to:
perform the channel measurement on a corresponding measurement resource based on the first configuration information by receiving a reference signal sent by the network side device.

In some embodiments, the radio frequency unit 1101 is further configured to:
report the measurement result obtained by the channel measurement to the network side device.

In some embodiments, the radio frequency unit 1101 is further configured to:
transmit the measurement result on a corresponding first reporting resource based on the reporting configuration information; or
transmit the measurement result on a second reporting resource, where the second reporting resource is used by the terminal to report backscatter-related information.

In some embodiments, the radio frequency unit 1101 is further configured to:
send a reference signal to the network side device based on the second configuration information.

In some embodiments, the radio frequency unit 1101 is further configured to:
obtain a transmission strategy adjustment indication of the network side device.

The processor 1110 is further configured to:
adjust a transmission parameter of backscatter communication according to the transmission strategy adjustment indication, where the transmission strategy adjustment indication is determined by the network side device based on the measurement result.

In some embodiments, the measurement configuration information includes at least one of the following:
a measurement resource;
a measurement metric;
a periodicity type;
a periodicity length; and
reference signal-related configuration information.

In some embodiments, the periodicity type includes at least one of the following:
periodic;
semi-static; and
aperiodic.

In some embodiments, the reference signal includes at least one of the following:
a carrier wave;
a control command; and
a preamble.

In some embodiments, the reference signal-related configuration information includes at least one of the following:
time domain resource information;
frequency domain resource information;
transmit power information;
a modulation scheme;
a coding scheme;
a mapping scheme;
resource density; and
a signaling format.

In some embodiments, the measurement metric includes at least one of the following:
RSRP;
RSRQ;
an RSSI;
a SINR; and
a CQI.

In some embodiments, the RSRP is received signal power on a resource that carries a reference signal within first bandwidth and centered on a first frequency.

The RSSI is received signal power within second bandwidth and centered on a second frequency.

The RSRQ is obtained based on the RSRP and the RSSI.

The SINR is obtained based on received power of a useful signal, interference power, and noise power.

The CQI is obtained based on at least one of the following:
reception of a single antenna, a rank indicator being equal to 1, and a preset precoding matrix indication.

In some embodiments, the reporting configuration information includes at least one of the following:
a periodicity type;
a periodicity length; and
reporting resource information.

In some embodiments, a frequency at which the terminal performs the channel measurement is larger than or equal to a frequency at which the measurement result is reported based on the channel measurement.

An embodiment of this application further provides a network side device, including a processor and a communication interface. The communication interface is configured to send at least one of the following:
measurement configuration information, where the measurement configuration information is used for channel measurement between a network side device and a backscatter device; and
reporting configuration information, where the reporting configuration information is used to report a measurement result obtained by the channel measurement.

This network side device embodiment is corresponding to the foregoing method embodiment of the network side device. Each implementation process and implementation of the foregoing method embodiment may be applicable to this network side device embodiment, and a same technical effect can be achieved.

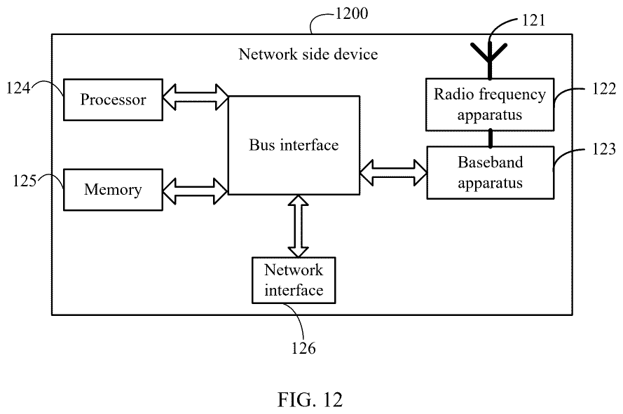

For example, an embodiment of this application further provides a network side device. As shown in FIG. 12, the network side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes information that needs to be sent, and sends processed information to the radio frequency apparatus 122. The radio frequency apparatus 122 processes the received information, and sends processed information through the antenna 121.

In the foregoing embodiment, the method performed by the network side device may be implemented in the baseband apparatus 123. The baseband apparatus 123 includes a baseband processor.

For example, the baseband apparatus 123 may include at least one baseband board. A plurality of chips are disposed on the baseband board. As shown in FIG. 12, one chip is, for example, a baseband processor, and is connected to the memory 125 by using a bus interface, to invoke a program in the memory 125 to perform the operations of the network device shown in the foregoing method embodiment.

The network side device may further include a network interface 126, and the interface is, for example, a common public radio interface (CPRI).

For example, the network side device 1200 in this embodiment of this application further includes an instruction or a program that is stored in the memory 125 and that can run on the processor 124. The processor 124 invokes the instruction or the program in the memory 125 to perform the method performed by the modules shown in FIG. 10, and a same technical effect is achieved. To avoid repetition, details are not described herein again.

An embodiment of this application further provides a readable storage medium. The readable storage medium stores a program or an instruction. When the program or the instruction is executed by a processor, the foregoing embodiment of the measurement processing method performed by the terminal is implemented, or the foregoing processes of the embodiment of the measurement processing method performed by the network side device are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction, to implement the foregoing embodiment of the measurement processing method performed by the terminal, or to implement the foregoing processes of the embodiment of the measurement processing method performed by the network side device, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the foregoing embodiment of the measurement processing method performed by the terminal or to implement the foregoing processes of the embodiment of the measurement processing method performed by the network side device, and a same technical effect can be achieved. To avoid repetition, details are not described herein again.

An embodiment of this application further provides a measurement processing system, including a terminal and a network side device. The terminal may be configured to perform the steps of the measurement processing method performed by the terminal, and the network side device may be configured to perform the steps of the measurement processing method performed by the network side device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A measurement processing method, comprising:
obtaining, by a terminal, at least one of the following:
measurement configuration information, wherein the measurement configuration information is used for channel measurement between a network side device and a backscatter communication device; or
reporting configuration information, wherein the reporting configuration information is used to report a measurement result obtained by the channel measurement.

2. The method according to claim 1, wherein the measurement configuration information comprises at least one of the following:
first configuration information, wherein the first configuration information is used by the terminal to perform the channel measurement; or
second configuration information, wherein the second configuration information is used by the network side device to perform the channel measurement.

3. The method according to claim 2, further comprising:
performing, by the terminal, the channel measurement on a corresponding measurement resource based on the first configuration information by receiving a reference signal sent by the network side device.

4. The method according to claim 3, further comprising:
reporting, by the terminal, the measurement result obtained by the channel measurement to the network side device.

5. The method according to claim 4, wherein the reporting, by the terminal, the measurement result obtained by the channel measurement to the network side device comprises:
transmitting, by the terminal, the measurement result on a corresponding first reporting resource based on the reporting configuration information; or
transmitting, by the terminal, the measurement result on a second reporting resource, wherein the second reporting resource is used by the terminal to report backscatter-related information.

6. The method according to claim 2, further comprising:
sending, by the terminal, a reference signal to the network side device based on the second configuration information.

7. The method according to claim 3, further comprising:
obtaining, by the terminal, a transmission strategy adjustment indication of the network side device; and
adjusting, by the terminal, a transmission parameter of backscatter communication according to the transmission strategy adjustment indication, wherein the transmission strategy adjustment indication is determined by the network side device based on the measurement result.

8. The method according to claim 1, wherein the measurement configuration information comprises at least one of the following:
a measurement resource;
a measurement metric;
a periodicity type;
a periodicity length; or
reference signal-related configuration information.

9. The method according to claim 8, wherein the periodicity type comprises at least one of the following:
periodic;
semi-static; or
aperiodic.

10. The method according to claim 8, wherein the reference signal comprises at least one of the following:
a carrier wave;
a control command; or
a preamble.

11. The method according to claim 8, wherein the reference signal-related configuration information comprises at least one of the following:
time domain resource information;
frequency domain resource information;
transmit power information;
a modulation scheme;
a coding scheme;
a mapping scheme;
resource density; or
a signaling format.

12. The method according to claim 8, wherein the measurement metric comprises at least one of the following:
reference signal received power (RSRP);
reference signal received quality (RSRQ);
received signal strength indication (RSSI);
a signal to interference plus noise ratio (SINR); or
a channel quality indicator (CQI).

13. The method according to claim 12, wherein the RSRP is received signal power on a resource that carries a reference signal within first bandwidth and centered on a first frequency;
the RSSI is received signal power within second bandwidth and centered on a second frequency;
the RSRQ is obtained based on the RSRP and the RSSI;
the SINR is obtained based on received power of a useful signal, interference power, and noise power; and
the CQI is obtained based on at least one of the following:
reception of a single antenna, a rank indicator being equal to 1, or a preset precoding matrix indication.

14. The method according to claim 1, wherein the reporting configuration information comprises at least one of the following:
a periodicity type;
a periodicity length; or
reporting resource information, or
wherein a frequency at which the terminal performs the channel measurement is larger than or equal to a frequency at which the measurement result is reported based on the channel measurement.

15. A measurement processing method, comprising:
sending, by a network side device, at least one of the following:
measurement configuration information, wherein the measurement configuration information is used for channel measurement between the network side device and a backscatter device; or
reporting configuration information, wherein the reporting configuration information is used to report a measurement result obtained by the channel measurement.

16. The method according to claim 15, wherein the measurement configuration information comprises at least one of the following:
first configuration information, wherein the first configuration information is used by a terminal to perform the channel measurement; or
second configuration information, wherein the second configuration information is used by the network side device to perform the channel measurement.

17. The method according to claim 16, further comprising:
sending, by the network side device, a reference signal to the terminal based on the first configuration information.

18. The method according to claim 17, further comprising:
receiving, by the network side device, a measurement result reported by the terminal.

19. The method according to claim 16, further comprising:
determining, by the network side device, a transmission strategy adjustment indication based on the measurement result; and
performing, by the network side device, at least one of the following:
instructing to adjust a transmission parameter of backscatter communication according to the transmission strategy adjustment indication; or
sending the transmission strategy adjustment indication to the terminal.

20. A terminal, comprising a processor and a memory storing instructions, wherein the instructions, when executed by the processor, cause the processor to perform operations comprising:
obtaining at least one of the following:
measurement configuration information, wherein the measurement configuration information is used for channel measurement between a network side device and a backscatter communication device; or
reporting configuration information, wherein the reporting configuration information is used to report a measurement result obtained by the channel measurement.
